(19) United States
(12) Patent Application Publication
(10) Pub. No.: US 2005/0170065 A1
(43) Pub. Date: Aug. 4, 2005

(54) Soybean noodle

(76) Inventors: Cunku Xi, (US); Yuhua Zhang, (US); Xuming Zhang, (US)

Correspondence Address: JACOBSON HOLMAN PLLC, 400 SEVENTH STREET N.W., SUITE 600, WASHINGTON, DC, 20004, US

(21) Appl. No.: 10/830,058

(22) Filed: Apr. 23, 2004

(30) Foreign Application Priority Data
Feb. 4, 2004 (CN) 2004100390973

(51) Int. Cl. A23L 1/31

(52) U.S. Cl. 426/634

(57) ABSTRACT

The present invention is related to a new soybean noodle. This noodle comprises 4 to 10 parts by weight of soybean powder and 2 to 4 parts by weight of wet bean-curd residue with water content of 60%˜80%. Moreover, the noodle may also comprise 0.5 to 2 parts by weight of soybean protein powder. The processing steps are as follows: peeling, defatting and crushing the soybean into powder of 70-120 mesh size; then mixing uniformly the treated powder with wet bean-curd residue and soybean protein powder; and finally extruding and aging the mixture to form finished noodle product using the extruder under the condition of high-temperature and high-pressure. This noodle features rich and balanced in nutrient. Besides rich plant protein, the said noodle comprises dietary fiber with the content up to 3%˜12%. The said noodle tastes delicious without soybean odor. When it is cooked, it is non-sticky and not easy to break. The noodle is suitable for all kinds of consumer groups. Especially, it is a perfect health-care food for adiposis, diabetes, cardiovascular disease and constipation patients and old people.

### TECHNICAL FIELD

This invention is related to a noodle. Preferably, the invention relates to a noodle being rich in plant protein and dietary fibre and using soybean as raw material.

### BACKGROUND ART

It is well known that soybean has a high content of plant protein, which is rich in all kinds of essential amino acids and trace elements. What's more, the soybean contains linoleic acid and oligosaccharide that can improve immunity. Because of the above advantages, people like to eat food made from soybean. China patent (CN-A-1439291) describes a soybean full-cream noodle and its production process. The soybean full-cream noodle is completely made from the soybean powder. The shortcoming of the noodle is that it had a low content of dietary fibre and a harshness taste and soybean odour, which caused it not easy to be popularized in staple-food market. Moreover, the health-care effect of the noodle is not outstanding enough to win the especial consumer groups' favour.

### CONTENTS OF THE INVENTION

The object of this present invention is to provide a soybean noodle being rich in dietary fibre and having delicious taste.

The object is carried out through the steps as follows:

This noodle of this invention comprises 4 to 10 parts by weight of soybean powder and 2 to 4 parts by weight of wet bean-curd residue with water content of 60%˜80%.

Preferably, this noodle comprises 7 part by weight of soybean powder and 3 part by weight of wet bean-curd residue with water content of 60%˜80%.

This noodle may comprise 4 to 10 parts by weight of soybean powder, 2 to 4 parts by weight of wet bean-curd residue with water content of 60%˜80% and 0.5 to 2 parts by weight of soybean protein powder. Preferably, this noodle may comprise 6 part by weight of soybean powder, 3 part by weight of wet bean-curd residue with water content of 60%˜80% and 1 part by weight of soybean protein powder.

The said wet bean-curd residue with water content of 60%˜80% is a byproduct from the process producing soybean protein powder from the soybean under the condition of low-temperature. Moreover, the additives and auxiliary materials etc. used commonly in the production process of noodles can be added to the materials. The materials are used to produce the soybean noodle according to the conventional method in noodle-making field. Then it can be used to produce instant noodles, silky bean milk rolls, silky bean curd and so on according to the conventional method in noodle-making field.

A preferable processing for preparing the said noodle comprises the following sequential steps:
1) Pretreatment: he dry soybean was peeled and defatted 50˜100% by extruding and then the defatted soybean was crushed into powder of 70-120 mesh size;
2) Preparing the following materials: 4 to 10 parts by weight of the said soybean powder, 2 to 4 parts by weight of wet bean-curd residue with water content of 60%˜80% and 0.5 to 2 parts by weight of soybean protein powder were weighted;
3) The soybean powder was mixed uniformly with wet bean-curd residue and soybean protein powder, then the mixture was extruded and aged to finished noodle product within 1˜5 minutes at a temperature of 100˜190° C. and at a pressure of 6˜8 atm using the extruder, and said noodle was finally shaped into strip-like, filar or sheet-like.

In the above steps, the defatted 50% soybean is preferable.

The said soybean powder, wet bean-curd residue and soybean protein powder can be got from the market. Moreover, the soybean powder can be obtained by using mentioned method of this invention.

The wet bean-curd residue has three functions:

Firstly, the bean-curd residue has rich cellulose, which may improve the gastrointestinal movement and metabolism, lose one's appetite and decrease the absorption of sugar and fat so that the bean-curd residue can be used in the auxiliary treatment of adiposis, diabetes, cardiovascular disease and constipation. Moreover, the cellulose can improve the toughness and elasticity of the said noodle so that make it non-sticky and not easy to break when the noodle is cooked;

Secondly, the wet bean-curd residue decreases the absolute amount of soybean powder in the mixture so that it can effectively reduce soybean odour in the noodle;

Thirdly, wet bean-curd residue contains water needed in the production processing soybean noodle, so no additional water need be added in the process of this invention.

The said soybean protein powder has a high protein content up to 85%˜90%. The total content of protein in said soybean noodle can increase by adding 0.5 to 2 parts by weight of soybean protein powder. All of above can make the soybean noodle taste delicious and soft and have good color so that it can win the consumer groups' favour.

This noodle tastes delicious without soybean odour and features rich and balanced in nutrient. The said noodle comprises protein with the content up to 40%˜45% and dietary fibre with the content up to 3%˜12% and fat with the content up to about 3%˜9%. The noodle is suitable for all kinds of consumer groups as staple food. Especially, it is a perfect health-care food for adiposis, diabetes, cardiovascular disease and constipation patients and old people.

All percents used in this invention are wt %.

### MODE OF CARRYING OUT THE INVENTION

### EXAMPLE 1

Pretreatment: The dry soybean was peeled and defatted 50% by extruding and then the defatted soybean was crushed into semi-defatted soybean powder of 100 mesh size;

Preparing the following materials: Soybean powder 7 kg and wet bean-curd residue (water content of 60%˜80%) 3 kg were weighted;

The said soybean powder was uniformly mixed with wet bean-curd residue, then the mixture was extruded and aged to form noodle product at a temperature of 150° C. and at a pressure of 8 atm for 3 minutes using the extruder. The shape of said noodle may be strip-like, filar or sheet-like.

### EXAMPLE 2

Pretreatment: The dry soybean was peeled and defatted 100% by extruding and then the defatted soybean was crushed into full-defatted soybean powder of 120 mesh size;

Preparing the following materials: Soybean powder 7.5 kg and wet bean-curd residue (water content of 60%˜80%) 2.5 kg were weighted;
the said soybean powder was uniformly mixed with wet bean-curd residue, then the mixture was extruded and aged at a temperature of 180° C. and at a pressure of 8 atm for 2 minutes using the extruder to form noodle product. The shape of said noodle may be strip-like, filar or sheet-like.

### EXAMPLE 3

Pretreatment: The dry soybean was peeled and defatted 100% by extruding and then the defatted soybean was crushed into full-defatted soybean powder of 120 mesh size;

Preparing the following materials: Soybean powder 5 kg and wet bean-curd residue (water content of 60%˜80%) 3.5 kg and soybean protein powder 1.5 kg were weighted;

The said soybean powder was uniformly mixed with wet bean-curd residue and soybean protein powder, then the mixture was extruded and aged at a temperature of 100° C. and at a pressure of 6 atm for 5 minutes using the extruder to form finished noodle product. The shape of said noodle may be strip-like, filar or sheet-like.

### EXAMPLE 4

Pretreatment: The dry soybean was peeled and defatted 80% by extruding and then the defatted soybean was crushed into powder of 70 mesh size;

Preparing the following materials: Soybean powder 7.5 kg and wet bean-curd residue (water content of 60%˜80%) 1.5 kg and soybean protein powder 1 kg were weighted;

The said soybean powder was uniformly mixed with wet bean-curd residue and soybean protein powder, then the mixture was extruded and aged at a temperature of 190° C. and at a pressure of 7 atm for 2 minutes using the extruder to form finished noodle product. The shape of said noodle may be strip-like, filar or sheet-like.

1: A soybean noodle comprising 4 to 10 parts by weight of soybean powder and 2 to 4 parts by weight of wet bean-curd residue with water content of 60%˜80%.

2: A soybean noodle of claim 1, wherein said noodle comprises 7 part by weight of soybean powder and 3 part by weight of wet bean-curd residue with water content of 60%˜80%.

3: A soybean noodle of claim 1, wherein said noodle further comprises 0.5 to 2 parts by weight of soybean protein powder.

4: A soybean noodle of claim 3, wherein said noodle comprises 6 part by weight of soybean powder and 3 part by weight of wet bean-curd residue with water content of 60%˜80% and 1 part by weight of soybean protein powder.

5: A soybean noodle of claim 1, wherein said wet bean-curd residue with water content of 60%˜80% is a byproduct from the production of soybean protein powder processing from the soybean under the condition of low-temperature.

6: A soybean noodle of claim 1, wherein said soybean powder is defatted 50%.

7: A soybean noodle of claim 1, wherein said noodle can be used to produce instant noodles, silky bean milk rolls, silky bean curd and so on according to the conventional method in noodl-making field.

8: A method for preparing a soybean noodle comprising the following sequential steps:
1) Pretreatment: The dry soybean was peeled and defatted 50˜100% by extruding and then the defatted soybean was crushed into powder of 70-120 mesh size;
2) Preparing the following materials: 4 to 10 parts by weight of the said soybean powder, 2 to 4 parts by weight of wet bean-curd residue with water content of 60%˜80% and 0.5 to 2 parts by weight of soybean protein powder were weighted;
3) The soybean powder was uniformly mixed with wet bean-curd residue and soybean protein powder, then the mixture was extruded and aged to finished noodle product within 1˜5 minutes at a temperature of 100˜190° C. and at a pressure of 6˜8 atm using the extruder, and said noodle was finally shaping into strip-like, filar or sheet-like.
